(19) United States
(12) Patent Application Publication
(10) Pub. No.: US 2025/0004359 A1
(43) Pub. Date: Jan. 2, 2025

(54) STACKED APERTURES FOR STRAY LIGHT MITIGATION IN MICRO-PROJECTORS

(71) Applicant: GOOGLE LLC, Mountain View, CA (US)

(72) Inventors: Daniel J. Effinger, Squamish (CA); Daniel Adema, Kitchener (CA)

(21) Appl. No.: 18/759,261

(22) Filed: Jun. 28, 2024

Related U.S. Application Data
(60) Provisional application No. 63/510,986, filed on Jun. 29, 2023.

(51) Int. Cl. G03B 21/20; G02B 27/01

(52) U.S. Cl. CPC G03B 21/208; G02B 27/0101; G02B 27/0172

(57) ABSTRACT

A micro-projection system for use in small electronic devices can benefit from an optical assembly equipped with light-absorbing apertures. The light-absorbing apertures can aid in reducing or eliminating stray light and associated ghost images from appearing on the display of the projection system. Modular units that include laminated stacks of such apertures, along with spacers, can be inserted into air gaps within the optical assembly. Such stacked units can be made cost effective to manufacture in high volume.

### CROSS-REFERENCE TO RELATED APPLICATION

This patent application claims the benefit of U.S. Application No. 63/510,986, filed on Jun. 29, 2023, and titled “Stacked Apertures for Stray Light Mitigation in Micro-Projectors,” which is incorporated by reference herein in its entirety.

### FIELD OF THE DISCLOSURE

The present disclosure relates to a projection system that prevents formation of ghost images and stray light on a display and improves optical performance metrics.

### BACKGROUND

Projection systems that project images onto a display can be compromised by ghost images that arise from stray reflections within the projection system. In some systems, stray light from within an optical assembly, e.g., a lens or series of lenses, can result in ghosting. Reflections can be reduced by altering surface finishes on elements within the optical assembly. However, the small dimensions in a micro-projector pose a challenge to controlling surface features, e.g., surface roughness.

### SUMMARY

The present disclosure describes methods and systems for improving image quality in a micro-projection system, by incorporating stacked apertures into an optical assembly. The stacked apertures absorb stray light at a range of different angles to prevent ghosting.

In some aspects, the techniques described herein relate to a system, including: a housing; a plurality of optical elements stacked within the housing to form an optical assembly; and a stack of opaque frames disposed between a first optical element and a second optical element, the stack of opaque frames defining a series of light absorbing apertures around a perimeter of the optical assembly.

In some aspects, the techniques described herein relate to a method, including: forming openings on a first flexible sheet, the openings arranged in an array; arranging the first flexible sheet and a second flexible sheet in a stack using a lamination process; singulating the stack to form individual stacked units, each unit including one of the openings; and inserting an individual stacked unit into an optical assembly.

In some aspects, the techniques described herein relate to a micro-projector, including: a housing; a light source; a lens disposed within the housing, the lens including optical elements arranged to direct light projected by the light source onto a display, the optical elements separated by an air gap; and stacked apertures disposed in the air gap to absorb stray light around a perimeter of the lens.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1 is a ray diagram of a micro-projector, according to a possible implementation of the present disclosure.

FIG. 2A is a pictorial perspective view of an optical assembly housing, according to a possible implementation of the present disclosure.

FIG. 2B is a cutaway perspective view showing an interior surface of the housing of the optical assembly, according to a possible implementation of the present disclosure.

FIG. 3 is a cross-sectional view of the optical assembly shown in FIG. 1, according to a possible implementation of the present disclosure.

FIG. 4 is a cross-sectional view of the optical assembly shown in FIG. 3, according to a possible implementation of the present disclosure.

FIG. 5 illustrates various types of apertures, according to a possible implementation of the present disclosure.

FIG. 6A is a side view of apertures in an aperture sub-module, according to a possible implementation of the present disclosure.

FIG. 6B is a cross-sectional view of a spacer, according to a possible implementation of the present disclosure.

FIG. 6C is a cross-sectional view of a wide aperture, according to a possible implementation of the present disclosure.

FIG. 7 is a cross-sectional view of an optical assembly according to a possible implementation of the present disclosure.

FIGS. 8A, 8B, and 8C illustrate an assembly process for an aperture sub-module according to a possible implementation of the present disclosure.

FIGS. 9A, 9B, and 9C illustrate several configurations of an aperture sub-module according to a possible implementation of the present disclosure.

FIG. 10 is a magnified view of a portion of the optical assembly shown in FIG. 7, according to a possible implementation of the present disclosure.

FIG. 11 is a flow chart for a method of improving image quality in a micro-projector, according to a possible implementation of the present disclosure.

Components in the drawings are not necessarily to scale relative to each other. Like reference numerals designate corresponding parts throughout the several views.

### DETAILED DESCRIPTION

Mini-projectors and micro-projectors can project images from small electronic devices e.g., smartphones, onto various types of displays, such as a large screens for viewing by an audience. In some implementations, the display is part of a virtual reality (VR) headset. In some implementations, the display is part of an augmented reality (AR) headset. In some implementations, the display is a heads-up display in a vehicle. Micro-projectors include micro-sized optical assemblies containing micro-optical elements, e.g., micro-lenses. The scale of such micro-optical components can be on the order of millimeters (mm) to microns (μm).

At least one technical problem with micro-projectors that include very small optical elements is that the image quality on the display can be diminished by stray light that forms ghost images. A ghost image can appear as a replication of the true image or of portions of the true image. For example, a ghost image may appear as a color-faded, greyed-out, or muted copy of the true image, adjacent to the normal full color image on the display. In some instances, the ghost image may have a skewed orientation relative to the true image, e.g., the ghost image may be upside down compared with the true image. Such ghost images appearing on the display can be caused by reflections of stray light within the optical assembly.

The disclosed systems and methods provide a technical solution to reduce or eliminate ghosting. In some implementations, the optical assembly includes a lens and an air gaps, and the technical solution includes stacked apertures disposed in the air gap to absorb stray light around a perimeter of the lens. In some implementations, the lens can one or more optical elements arranged to direct light projected by the light source onto a display. By incorporating a stack of apertures formed on thin sheets into the optical assembly, stray light can be absorbed around a perimeter of the optical elements, while desired light continues to propagate through a center region (the aperture) of the optical assembly. An aperture can be created by introducing an opaque material into the path of a light ray or beam and creating a hole in the opaque material to allow the light ray to pass. An opaque frame around the perimeter of an optical assembly will block light rays reflected at the edges of lenses within the optical assembly, while the desired light rays propagate through the center of the frame. In some implementations, the opaque frame can be nominally in the form of an opaque ring having, for example, a circular shape that conforms to the shape of the housing 110. In some implementations, the opaque ring can have a shape different from a circular shape (e.g., an elliptical shape). The opaque frame, referred to herein as an “aperture,” can be made of a metal or a polymer e.g., plastic, among other materials. Light absorption of a single aperture can be optimized by altering surface properties of the material such as reflectivity, surface roughness, and so forth.

Although individual apertures have been used in the past in an attempt to reduce ghosting, stacked apertures are much more effective, but also much more difficult to manufacture, especially in high volume. Use of a stack of apertures allows for more variables to optimize the light absorption. For example, spacers can be placed between apertures in the stack, and the thicknesses of the layers can be varied. Also, the dimensions of the openings in the stacked sheets can be varied. and the one reason for the manufacturing challenges is that the aperture sheets are very thin, on the order of only a few microns. A method of manufacturing stacked sheets of apertures and spacers using lamination techniques designed for very thin sheets is described.

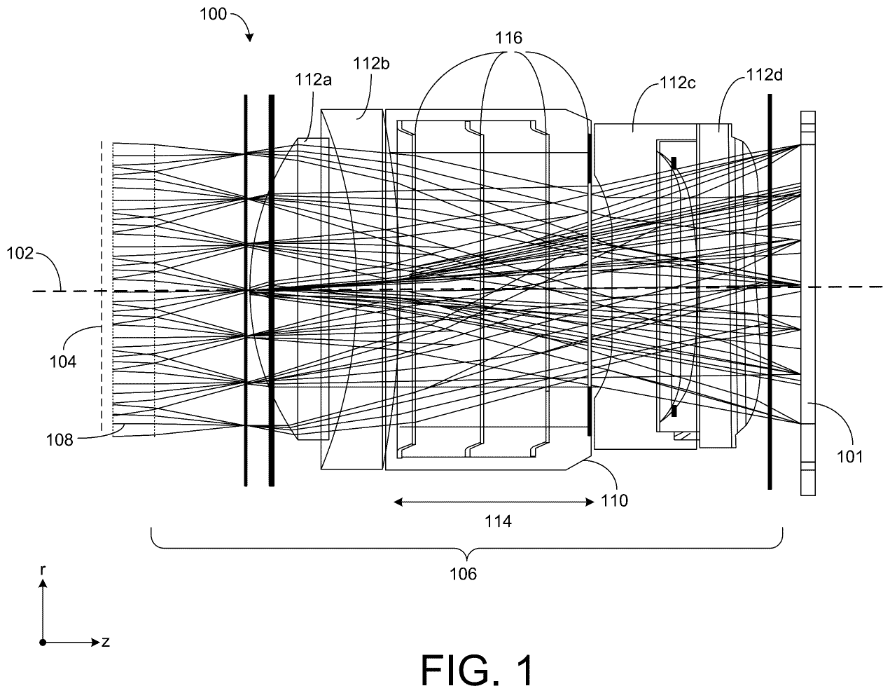

FIG. 1 shows an idealized ray diagram of a micro-projector 100, according to a possible implementation of the present disclosure. The micro-projector 100 includes a light source 101 that emits light in a direction parallel to a longitudinal axis 102. The micro-projector 100 further includes a display 104, and an optical assembly 106 inserted between the light source 101 and the display 104. The light source 101 can be, for example, an array of LEDs, or any other type of light source that is suitable for use in the micro-projector 100. The light source 101 generates light rays 108 that propagate from right to left along the longitudinal axis 102 as shown in FIG. 1, through the optical assembly 106 for incidence on the display 104.

The optical assembly 106 includes a housing 110, lenses 112 (4 shown: 112a, 112b, 112c, and 112d), and an air gap 114. Examples of lenses shown in FIG. 1 include a convex lens 112a, a concave lens 112b, and compound lenses 112c and 112d. In some implementations, elements among the lenses 112 can be separated by the air gap 114. In some implementations, the air gap 114 can occupy a central region of the optical assembly 106, between, for example, the concave lens 112b and the compound lens 112c. In some implementations, the housing 110 can be configured with interior ribs 116 that form slots to support installation of additional lenses 112 or other optical components to assist in guiding the light rays 108 toward the display 104. Ideally, the light rays 108 can be guided through a central area of the optical assembly 106 by the lenses 112, without being reflected or absorbed by the structure, e.g., the wall of the housing 110.

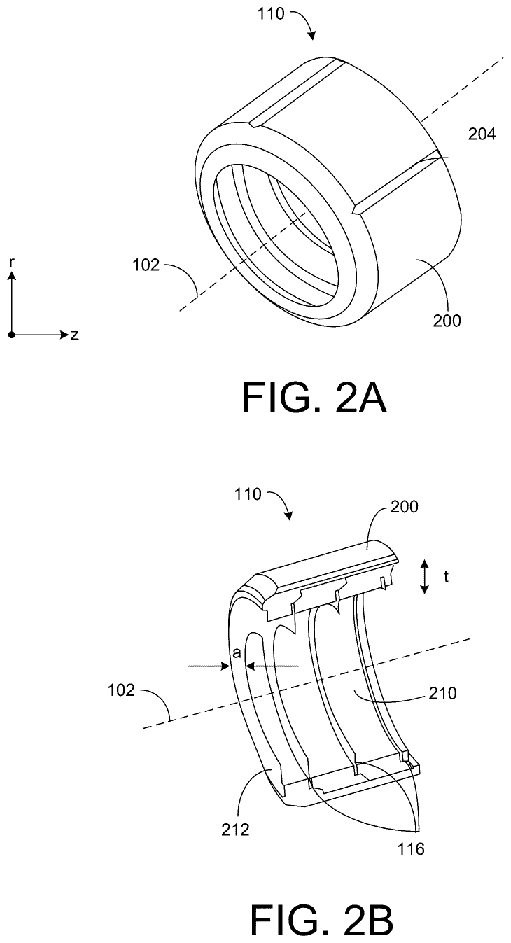

FIG. 2A is a pictorial perspective view of an exterior surface 200 of the housing 110 of the optical assembly 106, according to a possible implementation of the present disclosure. In some implementations, the housing 110 can be formed from, or include, a polymer, e.g., a plastic, material by a molding process, e.g., by injection molding. In some implementations, the housing 110 can be formed from, or can include, a metal material, e.g., aluminum. The housing 110 can have a cylindrical shape, symmetric about the longitudinal axis 102, in which the exterior surface 200 wraps around the ends to form a smooth, rounded exterior surface 200. In some implementations, the shape of the housing 110 is nominally that of a circular cylinder, but the housing 110, or portions of the housing 110, can also be shaped differently, e.g., as a non-circular cylinder, or irregularly shaped, e.g., with grooves, protrusions, or asymmetric features. In some implementations, the exterior surface 200 can include ribs 204 that extend along a length of the housing 110, parallel to the longitudinal axis 102. The housing 110 can also be referred to as a barrel.

FIG. 2B is a cutaway perspective view showing an interior surface 210 of the housing 110 of the optical assembly 106, according to a possible implementation of the present disclosure. The interior surface 210 of the housing may include features that control, e.g., restrict, rotation of the lenses 112. For example, the interior surface 210 can feature one or more interior ribs 116. The housing 110 has a radial thickness t between the exterior surface 200 and the interior surface 210. The interior ribs 116 provide structural support for the lenses 112 (not shown in FIG. 2B).

The interior ribs 116 also provide structural support for installation of one or more apertures 212 between the lenses 112. Features of the interior surface 210 can further control, e.g., restrict, rotation of the apertures. In some implementations, the apertures 212 can have the form of opaque, e.g., substantially opaque, rings made from thin sheets of a polymer, e.g., a glass-filled polymer. Individual apertures 212 can have longitudinal thicknesses on the order of microns. The opaque rings are formed around a periphery, e.g., a perimeter, of a central aperture through which light can pass. The aperture 212 are nominally circular but, in some implementations, apertures 212 may have an irregular shape, or a non-circular shape, e.g., a square shape, an elliptical shape, or a polygonal shape. In some implementations, the aperture 212 can be in the form of an opaque frame having a radial width a. In some implementations, the apertures 212 are made from a material and/or a color having an opacity characterized by absorption of at least 90% of the light emitted by the light source 101 that reaches the perimeter of the housing 110. Such a material may be considered as opaque or substantially opaque, given that opaque materials may not block exactly 100% of incident light rays. In some implementations, a material that is opaque allows some light (or some percentage) of some wavelengths to pass through the material. In some implementations, a material that is opaque allows some light (or some percentage) of some wavelengths to pass through the material, while not allowing other light (e.g., a specified percentage) of other wavelengths to pass through the material. In some implementations, the apertures 212 may feature an opaque thin film coating applied to a base material to absorb at least 90% of incident light on the aperture 212. In some implementations, the apertures 212 may feature an opaque thin film coating applied to a base material to block at least 90% of incident light on the aperture 212. In some implementations, the apertures 212 may feature an opaque thin film coating applied to a base material to prevent at least 90% of incident light on the aperture 212. In some implementations, absorbing, blocking, and/or preventing 90% of the incident light can be critical to desirable operation of the implementations described herein. In some implementations, a stack of opaque frames can be disposed between a first optical element and a second optical element. The stack of opaque frames can define a series of light absorbing apertures around a perimeter of the optical assembly.

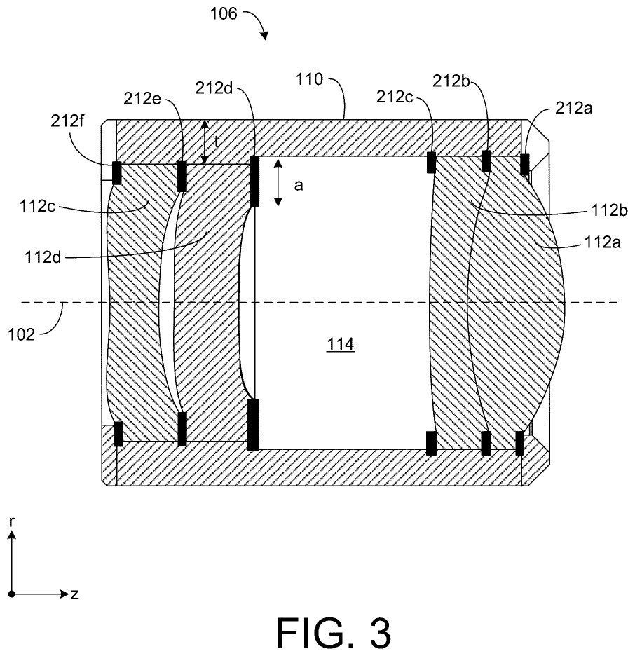

FIG. 3 is a cross-sectional view of the optical assembly 106 shown in FIG. 1, according to a possible implementation of the present disclosure. FIG. 3 shows the four lenses 112 and an air gap 114 in the central region of the optical assembly 106. FIG. 3 differs from FIG. 1 in that FIG. 3 further shows the addition of apertures 212 (5 shown: 212a, 212b, 212c, 212d, and 212c) disposed between adjacent lenses 112, e.g., lenses placed next to one another, which are sequential with respect to the light path. For example, aperture 212a is disposed next to convex lens 112a; aperture 212b is disposed between convex lens 112a and concave lens 112b; aperture 212c is disposed in the air gap 114 next to concave lens 112b; aperture 212d is disposed in the air gap 114 next to compound lens 112c; aperture 212e is disposed between compound lens 112c and compound lens 112d; and aperture 212f is disposed next to compound lens 112d. In the example shown in FIG. 3, all of the apertures 212 have different radial widths a. In the example shown in FIG. 3, all of the apertures 212 have a similar (longitudinal) thickness.

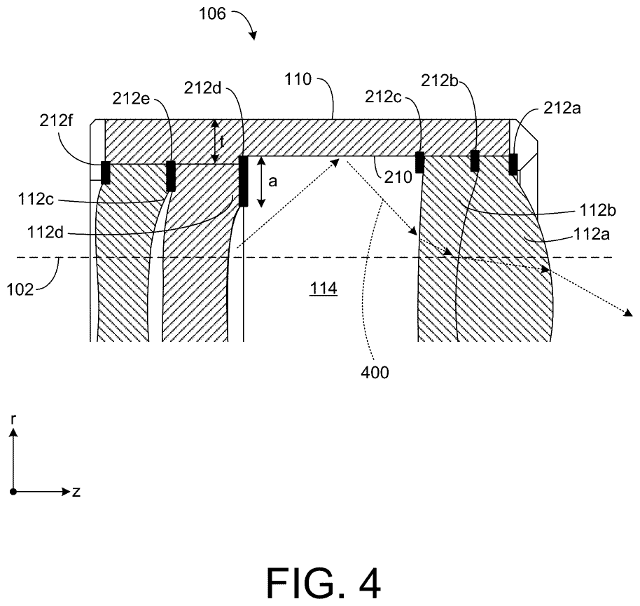

FIG. 4 is a cross-sectional view of the optical assembly 106 shown in FIG. 3, according to a possible implementation of the present disclosure. FIG. 4 additionally shows a reflected light ray 400, e.g., one of the light rays 108 that reflects off the interior surface 210 of the housing 110 in the air gap 114. The reflected light ray 400 can be referred to as a stray light ray because it follows a different path than the other light rays 108. When multiple reflected light rays 400 arise in the optical assembly 106, stray light can form a ghost image on the display 104, or optical performance can degrade due to haze, contrast effects, and so forth. Therefore, it is desirable to reduce the number of reflected light rays 400 as much as possible by introducing apertures 212 into the region of the air gap 114.

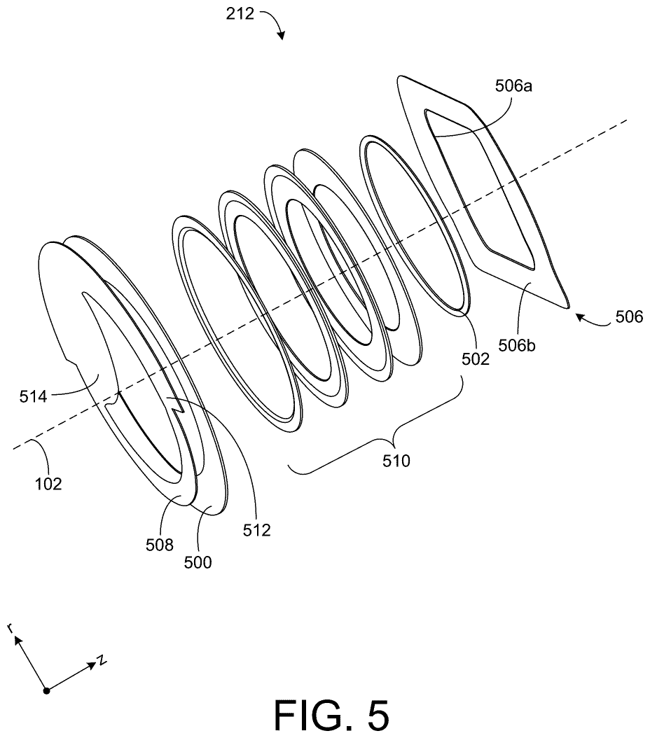

FIG. 5 shows various types of apertures 212, according to a possible implementation of the present disclosure. The various apertures 212 can be added to the design of the optical assembly 106, and in particular, to the air gap 114, to reduce the occurrence of reflected light rays 400. The examples of various apertures 212 shown in FIG. 5 include a wide aperture 500, a narrow aperture 502, a panel aperture 506 having an opening 506a and an outer perimeter 506b, an asymmetric aperture 508, and an aperture sub-module 510. For example, the narrow aperture 502 has a smaller radial width a, while the wide aperture 500 has a larger radial width a. Varying the radial width a is one way to tune, e.g., adjust, the shapes of apertures 212 to minimize ghosting. In addition, the panel aperture 506 can be used wherein the opening 506a has a different shape than the outer perimeter 506b of the opaque ring. For example, the opening 506a can be square while the outer perimeter 506b of the opaque ring of aperture 506 can be rounded, e.g., circular. In another example, the asymmetric aperture 508 can be introduced to further mitigate ghosting. The asymmetric aperture 508 can include features such as hooks 512 and add-ons 514. In some implementations, the shapes of the additional features of the asymmetric aperture 508 can be customized using trial and error or a prototype aperture to minimize ghosting.

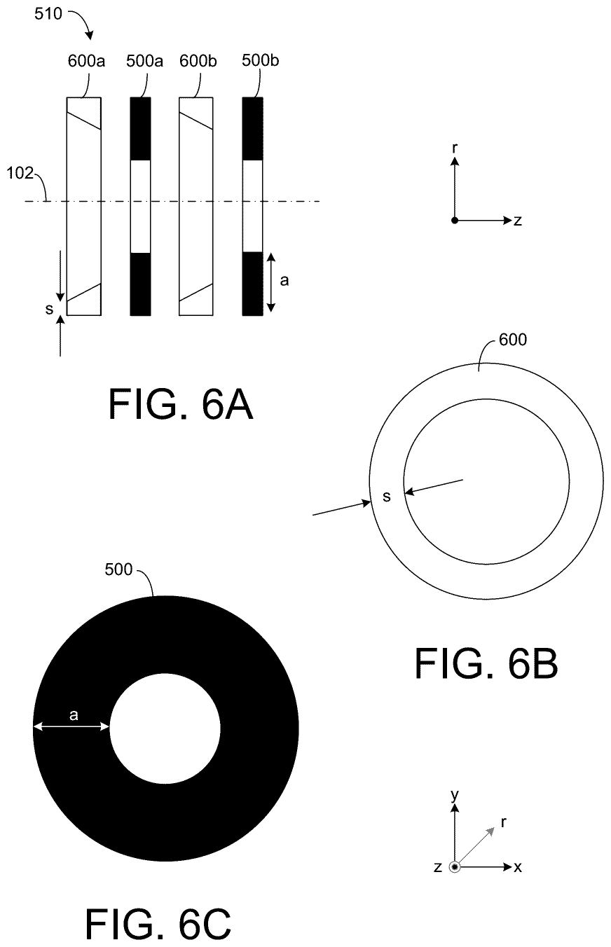

The aperture sub-module 510 can be disposed in the air gap 114 to reduce or eliminate ghosting by absorbing stray reflected light rays 400. In some implementations, the aperture sub-module 510 can be in the form of stacked apertures as described further below. Stacked apertures can be formed by layering multiple apertures using a lamination process. Stacked apertures, e.g., a stack of opaque frames, for use in micro-projectors are challenging to process because of their small scale dimensions. In particular, micron-scale thicknesses of apertures 212 within the aperture sub-module 510 pose a manufacturing challenge, especially for high-volume manufacturing. Solutions to these issues are described below with reference to FIGS. 6A-10.

FIG. 6A is a side view of apertures 212 that can be combined into the aperture sub-module 510, according to a possible implementation of the present disclosure. The aperture sub-module 510 can be inserted into the air gap 114 to mitigate ghosting on the display 104. In the example shown in FIG. 6A, two apertures 212 are included, a first wide aperture 500a and a second wide aperture 500b. The arrangement of apertures 212 as shown in FIG. 6A further includes spacers 600 (two shown: 600a and 600b). The spacers 600 can be inserted between the apertures 212 maintain the positions of the apertures 212 within the housing 110. The spacers 600 can include one or more materials such as glass, ceramics, polymers, composites, and metals.

FIG. 6B is a normal view of the spacer 600, which has a radial width s. The spacers 600 have a ring structure, similar to that of the apertures 212. However, the spacers 600 need not be opaque. Another difference between the spacers 600 and the apertures 212 is that the apertures 212 have a constant radial width a. That is, the radial width a of the apertures 212 does not vary longitudinally, e.g., in the z-direction. Whereas, the radial width s of the spacers 600 can change e.g., linearly, across the thickness of the spacer, in the z-direction. In some implementations, one or more of the spaces have a radial width that varies along a longitudinal axis of an optical assembly.

FIG. 6C is a normal view of the wide aperture 500 for comparison with the spacer 600. In the example shown, the radial width a of the wide aperture 500 is wider than the radial width s of the spacers 600. In this example, the wide apertures 500.

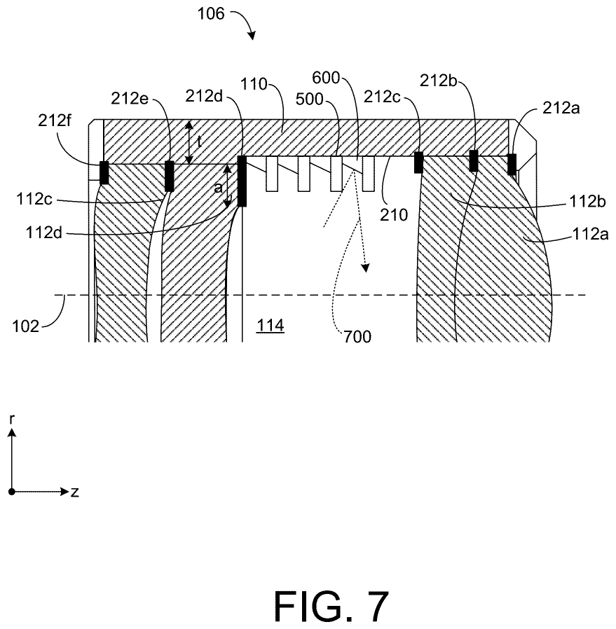

FIG. 7 is a cross-sectional view of the optical assembly 106 shown in FIG. 3 and FIG. 4, with the addition of a series of light absorbing apertures, e.g., wide apertures 500, and spacers 600, according to a possible implementation of the present disclosure. FIG. 7 shows the effect of adding the wide apertures 500 and the spacers 600 to the air gap 114 to mitigate ghosting. With the additional wide apertures 500 spaced apart from one another by spacers 600, the path of stray light rays can be altered. For example, the reflected light ray 400 as shown in FIG. 4 can be re-directed by the presence of the spacers 600 to follow a different path 700, thus preventing the ghost image from forming, or at least reducing the intensity of the ghost image on the display 104. In other words, in some implementations, the series of light absorbing apertures includes a first aperture and second aperture wherein the first aperture and the second aperture in the stack of opaque frames are spaced apart from one another by spacers.

Similarly, one or more narrow apertures 502 and associated spacer(s) can be added to the air gap 114 or substituted for the wide aperture 500, to alter reflections in a different way. Similarly, one or more panel apertures 506 and associated spacer(s) 600 can be added to the air gap 114 or substituted for one or more of the narrow aperture 502 or the wide aperture 500, to alter reflections in a different way. Similarly, one or more asymmetric apertures 508 and associated spacer(s) 600 can be added to the air gap 114 or substituted for one or more of the narrow aperture 502, the wide aperture 500, or the panel aperture 506, to alter reflections in yet a different way. Similarly, an aperture sub-module 510 can be added to the air gap 114 or substituted for one or more of the narrow aperture 502, the wide aperture 500, the panel aperture 506, or the asymmetric aperture 508, to alter reflections in a yet different way.

Use of the aperture sub-module 510 can introduce multiple types of apertures 212 and associated spacer(s) 600 in a single unit for insertion into the air gap 114. Consequently, one advantage of the aperture sub-module 510 is that it affords versatility and an opportunity to introduce more complex combinations of apertures 212 and spacers 600 to tune the micro-projector 100 by minimizing ghosting. For example, a set of different aperture sub-modules 510 can be created with various configurations, e.g., combinations, and/or spatial arrangements, of aperture types. Then each of the aperture sub-modules 510 can be introduced into a micro-projector 100 to test the efficacy of that configuration. When the best configuration is found, the corresponding sub-module can be mass produced for the micro-projector 100.

By extension, tests of the various configurations of aperture sub-module 510 can be performed using a predictive computer model, in a process of aperture optimization. Once an optimal combination of apertures 212 and spacers 600 is discovered using the computer model, a physical verification test can be done to confirm the reduction or elimination of ghosting, before committing to a large scale manufacturing run.

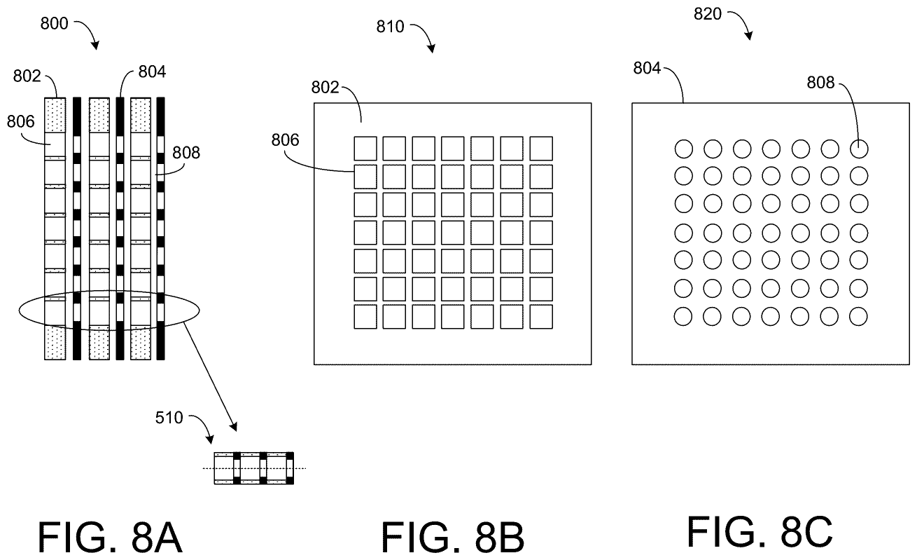

FIGS. 8A, 8B, and 8C illustrate an assembly process for the aperture sub-module 510, according to a possible implementation of the present disclosure. FIG. 8A is a side view of an arrangement 800 of alternating (e.g., alternating arrangement) spacer sheets 810 and aperture sheets 820 for stacking to form the stacked aperture sub-module 510.

FIG. 8C is a top plan view of a single aperture sheet 820 that illustrates a way of mass producing the apertures 212. In some implementations, the aperture sheet 820 is made of a flexible material, e.g., a polymer, so that the aperture sheet 820 is a flexible sheet. In some implementations, the aperture sheet 820 can be made of a very thin metal, e.g., aluminum having a thickness in a range of about 1 μm to about 5 μm, resulting in a flexible metal aperture sheet 820. In some implementations, the aperture sheet 820 may be patterned to form a square array of openings, e.g., round openings 808. The square array of round openings 808 (e.g., openings arranged in an array) is surrounded by a border region 804 that does not include round openings 808. For example. FIG. 8C shows a 7×7 array of round openings 808, which can yield 49 individual apertures 212.

However, instead of singulating individual apertures 212, in some implementations, the aperture sheets 820 and the spacer sheets 810 can be laminated in a prescribed sequence, to form, initially, a stack of flexible sheets (not shown). Then, the stack of flexible sheets can be singulated to form individual stacks of apertures 212 alternating with spacers 600 in the form of the stacked aperture sub-module 510. The singulation process will discard the border region 802 and the border region 804.

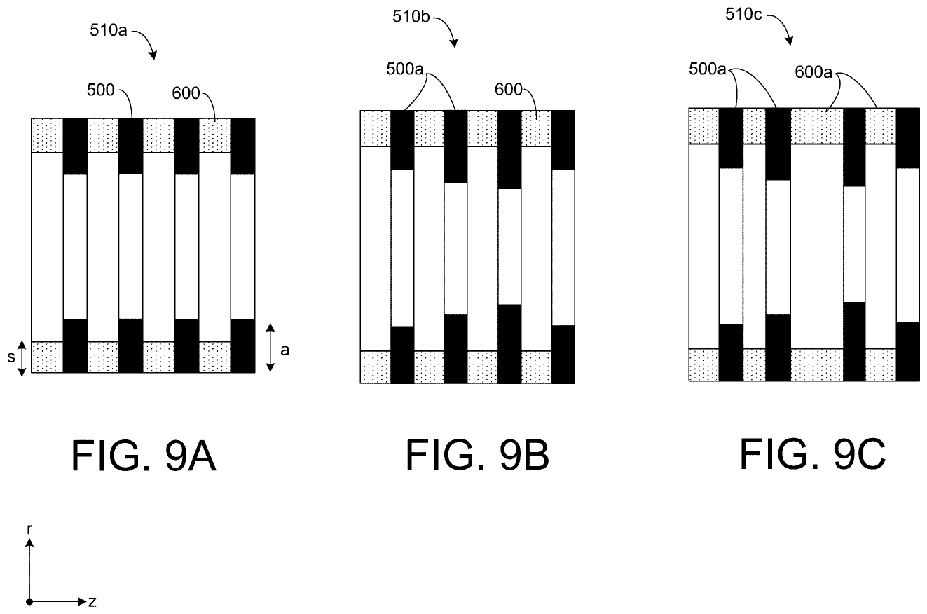

FIGS. 9A, 9B, and 9C illustrate several configurations of the aperture sub-module 510 according to a possible implementation of the present disclosure. The different configurations illustrate how various dimensions of the apertures and spacers can be adjusted to control ghosting. In some implementations, the number of sheets that can be stacked to form an aperture sub-module 510 is between 1 and 8 sheets. FIG. 9A shows an aperture sub-module 510a in which wide apertures 500 alternate with spacers 600. In some implementations, the spacers 600 can be replaced by adhesive layers so that the spacer. In the aperture sub-module 510a, the wide apertures 500 have the same radial width and the spacers 600 have the same radial width s. In the aperture sub-module 510a, the wide apertures 500 are all of uniform thickness and the spacers 600 are all of uniform thickness, wherein the spacers 600 are thicker than the wide apertures 500. In some implementations, thicknesses of the wide apertures 500 and/or the spacers 600 can be a few microns to a few tens of microns, for example, within a range of about 15 μm to about 25 μm. Adhesive layers used in place of spacers 600 can be as thin as about 50 μm.

FIG. 9B shows an aperture sub-module 510b in which wide apertures 500a alternate with spacers 600. In the aperture sub-module 510b, the wide apertures 500a have different radial widths while the spacers 600 have the same radial width s. In the aperture sub-module 510b, the wide apertures 500a are of uniform thickness and the spacers 600 are also of uniform thickness.

FIG. 9C shows an aperture sub-module 510c in which wide apertures 500a alternate with spacers 600a. In the aperture sub-module 510c, the wide apertures 500a have different radial widths while the spacers 600a have the same radial width s. However, in the aperture sub-module 510c, the wide apertures 500a are of uniform thickness while the spacers 600 have different thicknesses.

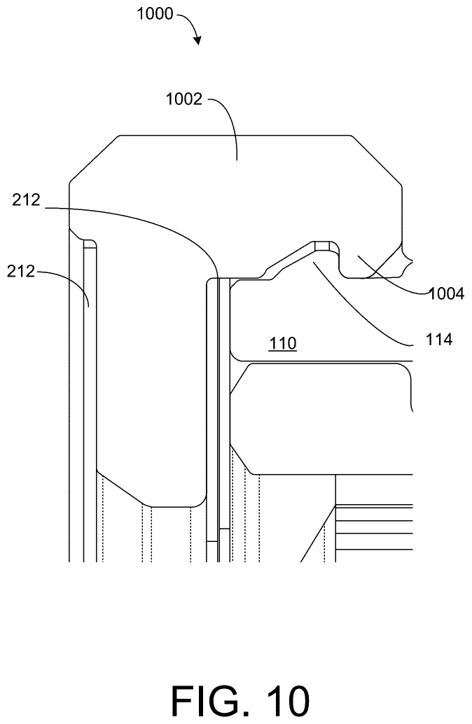

FIG. 10 is a magnified view of an interlocking device 1000, according to a possible implementation of the present disclosure. The interlocking device 1000 can be used to secure one or more apertures 212 to the housing 110. In some implementations, an interlocking spacer 1002 can be used to lock a structure that includes two individual apertures 212 to the housing 110. In some implementations, an interlocking spacer 1002 can be used to lock a structure that includes stacked apertures 212, e.g., an aperture sub-module 510 to the housing 110,

In some implementations, the interlocking spacer 1002 can be L-shaped so as to wrap around an edge of the aperture 212. In some implementations, the interlocking spacer 1002 can include a curved hook 1004. In some implementations, a first curved hook 1004 of a first interlocking spacer 1002 on one side of the aperture 212 can engage with (e.g., grip) a second curved hook 1004 that is integral to, e.g., formed as part of, the housing 110. In some implementations, the first curved hook 1004a can engage with (e.g., grip) a second curved hook 1004b in a second interlocking spacer 1002 on the other side of the aperture 212 to hold the aperture 212 securely in place.

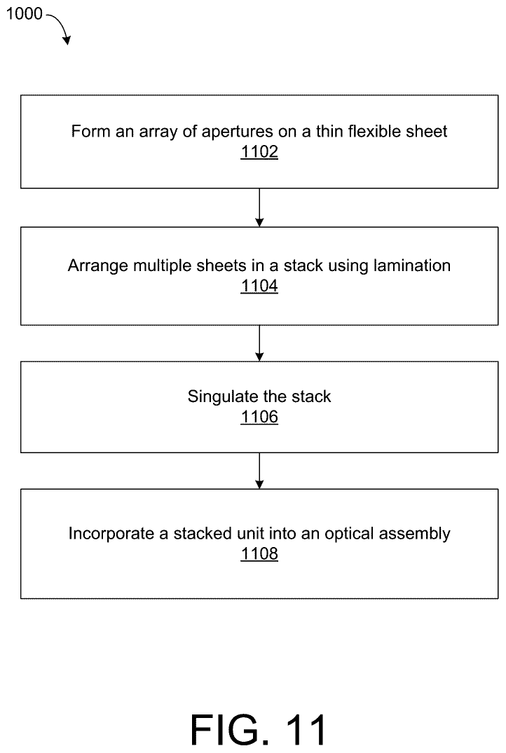

FIG. 11 illustrates a method 1100 for ghost image prevention in a micro-projector system, e.g., the micro-projector 100, according to a possible implementation of the present disclosure. Operations of the method 1100 can be performed in a different order, or not performed, depending on specific applications. The method 1100 may be performed using the apparatus shown in FIGS. 1, 2A, 2B, 3, 4, 5, 6A, 6B, 6C, 7, 8A, 8B, 8C, 9A, 9B, 9C, and 10 . . . . The method 1100 includes operations for high volume manufacturing of aperture elements for inclusion in an optical assembly. It is noted that the method 1100 may improve image quality on the display 104 but may not completely eliminate stray light or ghost images affecting the display 104. Accordingly, it is understood that additional processes can be provided before, during, or after the method 1100, and that some of these additional processes may be briefly described herein.

The method 1100 includes, at 1102, forming an array of openings, e.g., apertures on a thin flexible sheet, according to a possible implementation of the present disclosure. In some implementations, the array can be a square array, such as a 4×4 array, a 5×5 array, and so forth. Openings in the array can have various shapes. In some implementations, forming the openings includes forming openings having a circular shape, a square shape, an elliptical shape, or a polygonal shape. such as round, square, elliptical, polygonal, and so forth. The array of openings can be formed using standard patterning techniques such as lithography and etching. In some implementations, the thin flexible sheet can be an aperture sheet, or a spacer sheet. In some implementations, the array is of a size that supports high volume manufacturing. In some implementations, one or more flexible sheets can have a uniform thickness (e.g., a first flexible sheet and a second flexible sheet can be of a uniform thickness).

The method 1100 includes, at 1104, arranging multiple sheets in a stack using a lamination process, according to a possible implementation of the present disclosure. In some implementations, aperture sheets can alternate with spacer sheets within the stack. In some implementations, the lamination process can include use of one or more adhesives, e.g., pressure-sensitive adhesives or thermal set adhesives, or combinations thereof. In some implementations, the lamination process can include bonding, such as a fusing process, a gluing process, or a process of laser welding. In some implementations, the gluing process uses at least one of a pressure-sensitive adhesive or a thermal set adhesive.

The method 1100 includes, at 1106, singulating the stack, according to a possible implementation of the present disclosure. Singulating the stack of thin, flexible sheets to form individual stacked units, e.g., the aperture sub-modules 510, can entail cutting, sawing, grinding, or other singulation techniques used to singulate semiconductor wafers.

The method 1100 includes, at 1108, incorporating a stacked unit (e.g., an individual stacked unit) into an optical assembly, e.g., the optical assembly 106 of the micro-projector 100, according to a possible implementation of the present disclosure. In some implementations, the stacked unit can be inserted as a module between optical elements, e.g., between lenses of the micro-projector 100. In some implementations, the stacked unit can be inserted as a module, into an air gap within the optical assembly 106.

As described above, ghosting in a micro-projection system (e.g., system) can be reduced by incorporating stacked apertures into the optical assembly. The stacked apertures can be manufactured as modular units with spacers inserted between adjacent apertures. Image quality can be improved by varying dimensions of the spacers and the apertures. Stacked apertures can reduce costs by increasing manufacturability at high volume.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for case of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below”, or “beneath” other elements or features would then be oriented “above” the other elements or features. Thus, the term “below” can encompass both an orientation of above and below. The device may be otherwise oriented (rotated 70 degrees or at other orientations) and the spatially relative descriptors used herein may be interpreted accordingly.

Example embodiments of the concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example embodiments.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present embodiments.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

What is claimed is:

1. A system, comprising:
a housing;
a plurality of optical elements stacked within the housing to form an optical assembly; and
a stack of opaque frames disposed between a first optical element and a second optical element, the stack of opaque frames defining a series of light absorbing apertures around a perimeter of the optical assembly.

2. The system of claim 1, wherein the stack of opaque frames is interlocked to the housing.

3. The system of claim 1, wherein the series of light absorbing apertures includes a first aperture and second aperture, the first aperture and the second aperture in the stack of opaque frames are spaced apart from one another by spacers.

4. The system of claim 3, wherein the spacers include an adhesive.

5. The system of claim 3, wherein the spacers and the series of light absorbing apertures are in an alternating arrangement.

6. The system of claim 1, wherein the series of light absorbing apertures include a glass-filled polymer.

7. The system of claim 3, wherein the spacers have a radial width that varies along a longitudinal axis of the optical assembly.

8. The system of claim 1, wherein the optical assembly and the series of light absorbing apertures is part of a micro-projector.

9. The system of claim 1, wherein the series of light absorbing apertures absorb at least 90% of incident light.

10. A method, comprising:
forming openings on a first flexible sheet, the openings arranged in an array;
arranging the first flexible sheet and a second flexible sheet in a stack using a lamination process;
singulating the stack to form individual stacked units, each unit including one of the openings; and
inserting an individual stacked unit into an optical assembly.

11. The method of claim 10, wherein incorporating an individual stacked unit into an optical assembly includes incorporating the individual stacked unit into a gap between lens elements of the optical assembly.

12. The method of claim 10, wherein the first flexible sheet is substantially opaque.

13. The method of claim 10, wherein the lamination process includes bonding using at least one of a fusing process, a gluing process, or a process of laser welding.

14. The method of claim 13, wherein the gluing process uses at least one of a pressure-sensitive adhesive or a thermal set adhesive.

15. The method of claim 10, wherein the array is of a size that supports high volume manufacturing.

16. The method of claim 10, wherein forming the openings includes forming openings having a circular shape, a square shape, an elliptical shape, or a polygonal shape.

17. The method of claim 10, wherein the first flexible sheet and the second flexible sheet are of a uniform thickness.

18. A micro-projector, comprising:
a housing;
a light source;
a lens disposed within the housing, the lens including optical elements arranged to direct light projected by the light source onto a display, the optical elements separated by an air gap; and
stacked apertures disposed in the air gap to absorb stray light around a perimeter of the lens.

19. The micro-projector of claim 18, wherein the display is part of a virtual reality headset.

20. The micro-projector of claim 18, wherein the display is a heads-up display in a vehicle.
